(19) United States
(12) Patent Application Publication
(10) Pub. No.: US 2019/0244181 A1
(43) Pub. Date: Aug. 8, 2019

(54) Method for Selling and Buying Internet Bandwidth by Tokens

(71) Applicants: Anton Edelman, Netania (IL); Tsah Ezekiel, Oranit (IL)

(72) Inventors: Anton Edelman, Netania (IL); Tsah Ezekiel, Oranit (IL)

(21) Appl. No.: 15/889,219

(22) Filed: Feb. 6, 2018

(51) Int. Cl. G06Q 20/06; G06Q 20/38

(52) U.S. Cl. CPC G06Q 20/065; G06Q 20/382

(57) ABSTRACT

A method performed by processing device running on an internet device that enables an internet device user to sign up as a seller or as a buyer, enables an encrypted secured connection between the internet device of the buyer with the internet device of the seller, enables the seller to sell his excess mobile internet bandwidth, to determine which part of his bandwidth he agrees to sell, to set periods of time that the bandwidth part is free for sale, and determines price for the bandwidth, enables the buyer to buy internet bandwidth from sellers and to determine price he agrees to pay for a specific bandwidth, enables sellers and buyers to manage the payments by integrating a cashless payment system of specific token, and enables the buyer to find sellers in a specific location according to a decentralized method based on a barrier layer.

### TECHNICAL FIELD

The present invention refers to a method for selling and buying internet bandwidth by using specific tokens based on blockchain.

### BACKGROUND ART

Many users of internet devices in some circumstances need to have an internet connection with a different IP and on the same time many other users of internet devices in some circumstances wish and agree to sell their internet bandwidth, or part of it. In addition, many users may likely to agree to receive tokens in return for their excess bandwidth. The present invention offers an effective solution for that.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a block diagram that shows two internet devices (200), of a Seller and a Buyer, each of them includes a processing device (10) and a remote server (100) with a processing device (10).

### THE INVENTION

For the sake of fluency we will start with some definitions. The terms hereinafter have the meanings as stated beside each of them in this patent application and in the claims as well. These terms may be used in the application and the claims in plural or singular.

The term “internet device” refers to any kind of device which is designed to have internet connection, such as computers, tablets, smartphones and the like. The term “Seller” refers to a subscriber of an internet device with an internet connection who wishes and agrees to sell his bandwidth or part of it for certain period of time in return of certain exchange. The term “Buyer” refers to a holder of an internet device who wishes and agrees to buy bandwidth for certain period of time in return of certain exchange for use in his device.

The main object of the present patent application is to provide a method performed by processing devices (10) that is designed to enable users of internet devices (200) to manage selling and buying internet bandwidth and paying for that by using specific tokens.

The motivation to sell bandwidth is much known. Users are likely to buy a package that best suit their needs, with a fine balance between having enough data and spending the least. Sometimes users are left with more bandwidth than they could use, and they may wish and agree to sell their excess bandwidth, or part of it, for certain periods of times for certain amount of return.

The need for internet connection for internet devices is much known, and it is highly necessary in some circumstances. For example, there are some countries that block internet access to certain websites, and they are doing so by adding to a black list in the internet service providers that block any attempt to reach to the websites in that black list. When a user in that country use a bandwidth of a user in another country he can reach those banned websites. It should be understood that the internet connection between the Buyer in that country with censorship attitude to the Seller in the other country is done through those ISP, but the fact that the IP of the Seller is not included in the black list enables the Buyer to connect to the Seller internet device and through it to creates indirect connection to the desired websites.

A computer program is used as a framework for the overall operation of the method and for the sake of fluency we will use the terms “the computer program” and “the method” hereinafter in this connection and as having in general the same meaning. Users of internet devices can download the computer program which is performed on the processing devices (10) of the internet device, and may be also on processing devices in remote servers (100). The method performed by the processing device (10) running on internet device (200) and may also on processing device (10) in remote server (100). The method includes the following features:

A user can sign up as a Seller in the network of the computer program, which provides him with the following options: (a) Enabling the Seller to sell his excess internet bandwidth to other users who need it by enabling an internet connection between his internet device (hereinafter “Exit Node Internet Device”) to internet devices of Buyers (hereinafter “Node Internet Device”); (b) Enabling the Seller to determine which part of his bandwidth he wishes to sell; (c) Enabling the Seller to set periods of time that this bandwidth part is free for sale; (d) Enabling the Seller to determine the price he wants for his bandwidth; (e) Enabling the Seller to manage the payments that he receives from selling his bandwidth;

A user can sign up as a Buyer in the network of the computer program, which provides him with the following options: (a) Enabling the Buyer to buy internet bandwidth from Sellers by enabling an internet connection between his Node Internet Device to an Exit Node Internet Device of the Seller; (b) Enabling the Buyer to view a listing of Sellers of internet bandwidth in desired locations; (c) Enabling the Buyer to determine the price he agrees to pay for a specific bandwidth; (d) Enabling the Buyer to manage the payments that he pays for the bandwidth.

The computer program may also include security systems for preventing user abuses. The computer program may be integrated to a cashless payment system of the specific tokens. The cashless payment system enables the Sellers and the Buyers to buy the specific tokens and to manage the payments. The use of the tokens as the currency in the computer program makes it unique and serves as a motivator for buying and selling this specific token. It is understood that psychologically a person may have more motivation to receive a specific tokens than to buy it by using his own standard money. The Tokens which will be the way to pay in the computer program will be based on block-chain and on crypto-economic principles. The Tokens as such are expected to be tradable on external exchanges. It should be understood that the Token is not a digital currency or any kind of financial instrument and it serves as a digital goods. The computer program may be attractive to Sellers and Buyers also due to the simple payment structure; the Buyer may pay only for what he uses, with flexible pricing and cashless payment with the tokens.

The main basic features of the computer program are to enable the connections between Node Internet devices of Buyers with Exit Node Internet Devices of Sellers, and to enable the Buyers with the Node Internet Devices to find Sellers with an Exit Node Internet Devices. The connection between the Exit Node Internet Devices to the Node Internet Devices may be secured and encrypted.

Finding Exit Node Internet Devices for Buyers: On one hand, using centralized servers as trackers is easiest way. However, it is preferably to use decentralized method in order to make it difficult to block these communications. The goal is to make these connections between the Node Internet Devices through the Exit Node Internet Devices anonymous and to make it impossible to find out that the Node Internet Devices is surf by using Exit Node Internet Device, unlike as when using standard VPN or Tor. Another goal is to prevent governmental inspectors of those countries with censorship to collect information on the Sellers and their Exit Node Internet Devices in order to avoid possibility to add them to the black list in those ISPs of those countries. However, the computer program enables the ability for the Buyers to find Exit Node Internet Devices and the problem is that those government inspectors may use factious Buyers for collecting such information and adding these Sellers' IPs to the black list. Therefore, the computer program includes a layer that makes it difficult to collect the identification information of the Sellers and their Exit Node Internet Devices IPs (hereinafter “the Barrier Layer”).

The Barrier Layer will prevent the computer program to provides the Buyers with excessive information as to the available Exit Node Internet Devices, assuming that those government inspector may use fictitious Buyers for collecting this information and on the other hand to provide the genuine Buyers the possibility to receive the necessary information.

The computer program may be downloaded in advanced with several genuine Exit Node Internet Devices that in turn supply to the Buyer several, but not all, additional Exit Node Internet Devices IP addresses. It is possible that such kind of information will cost money, in order to add an additional obstacle for such collection of information by undesirable institutes.

For example: When a Buyer from Iran opens the computer program he may type the he needs an IP address as a USA user and the computer program finds for him a Seller in the USA. The computer program already includes several Sellers and if they are not free or they are not located in the USA then the computer transfer the request through these Sellers that already stored in the computer program of that Buyer to another users of the network and asking from them the necessary information about free Seller in the USA, and so on. It is possible to provide the Buyer part of the information to reach a Seller and to enable him to get the full identification information of the Seller only after paying for such connection, again, this in order to make those undesirable institutes to pay for collection this information.

The computer program can be used as an anti-censorship solution for developers, which can use it in their programs under the SDKs methods for eliminating the possibility of countries to block the access to their program. The computer program may provide SDK for integration it into mobile applications and software and provides developers the ability to send the traffic via Exit Node Internet Devices.

The computer program can be used as a platform for developers for generating revenues from software and applications. Usually, developers creates applications which used by millions of people and in many cases they cannot monetize them. The computer program may provide developers with the possibility to integrate it as SDK in their programs and applications as part of the agreement with the users and to collect revenues, in tokens, from the revenues of their user when they sell their bandwidth.

The computer program may also include an optimal pricing system that may be automatic or controlled by the users. The optimal pricing system is designed to connect the Buyers to the highest quality Seller comparing the pricing as well, based on similar systems of ecommerce.

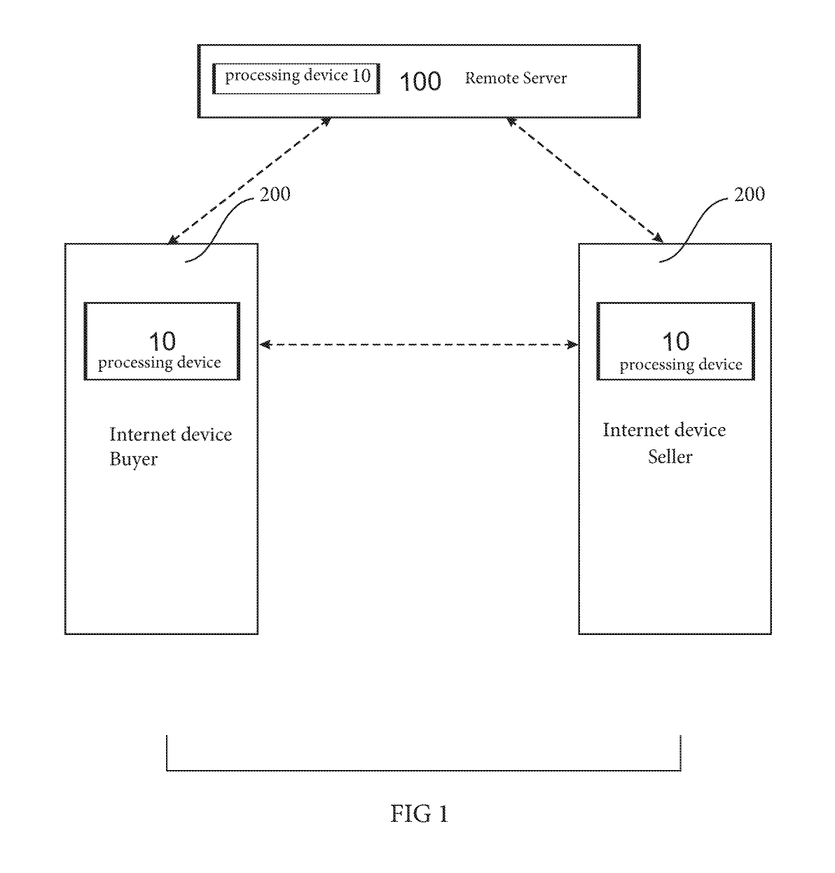

FIG. 1 is a block diagram that shows two internet devices (200), of a Seller and a Buyer, each of them includes a processing device (10) and a remote server (100) with a processing device (10).

What is claimed is:

1. A method performed by processing device running on an internet device, comprising:
(a) enabling an internet device user to sign up as a seller or as a buyer;
(b) enabling an encrypted secured connection between the internet device of the buyer with the internet device of the seller;
(b) enabling the seller to sell his excess mobile internet bandwidth, to determine which part of his bandwidth he agrees to sell, to set periods of time that said bandwidth part is free for sale, and determines price for said bandwidth;
(h) enabling the buyer to buy internet bandwidth from sellers and to determine price he agrees to pay for a specific bandwidth;
(j) enabling said sellers and buyers to manage the payments that they pays and receive by integrating a cashless payment system of specific token;
(z) enabling the buyer to find sellers in a specific location according to a decentralized method based on a barrier layer, whereby raising obstacles of unauthorized collecting information about sellers;
(z) whereby enabling developers to integrate the method under the SDKs principles as an anti-censorship solution against attempts to block the access to their programs and applications; and whereby enabling developers to integrate the method under the SDKs principles in their programs and applications as a platform for generating revenues from users of their software and applications.

2. The method performed by processing devices running on an internet device according to claim 1 that further includes an optimal pricing system.
